(19) United States
(12) Patent Application Publication
(10) Pub. No.: US 2008/0062518 A1
(43) Pub. Date: Mar. 13, 2008

(54) Optical device, imaging device, and electronic device

(75) Inventor: Michio Inoue, Saitama (JP)

Correspondence Address: FOLEY AND LARDNER LLP;SUITE 500, 3000 K STREET NW, WASHINGTON, DC, 20007, US

(73) Assignee: TAMRON CO., LTD.

(21) Appl. No.: 11/600,863

(22) Filed: Nov. 17, 2006

(30) Foreign Application Priority Data
Aug. 28, 2006 (JP) 2006-230558

(51) Int. Cl. G02B 27/22

(52) U.S. Cl. 359/468

(57) ABSTRACT

A lens device equipped with a G1 lens that transmits light in a direction of an optical axis and a fixed diaphragm that passes the light that has been passed through the G1 lens through an aperture open through in the direction of the optical axis toward a direction opposite to the G1 lens. A washer is provided between the G1 lens and the fixed diaphragm so as to face the G1 lens at a portion corresponding to a portion outside the aperture of the fixed diaphragm. The G1 lens is bonded to a rib of which position is fixed to the optical axis with an adhesive.

### BACKGROUND OF THE INVENTION

1. Field of the Invention

The present invention relates to an optical device, an imaging device, and electronic device.

2. Description of the Related Art

Recently, portable phones provided with an imaging function are widely used. Such portable phones are equipped with a lens unit for imaging. Some of the lens units have a plurality of lenses overlapped along the direction of the optical axis.

FIG. 5 is a cross-section of a conventional lens unit for imaging. As shown in FIG. 5, the lens unit 500 includes a G1 lens 501 and a G2 lens 502. A fixed diaphragm 503 is arranged between the G1 lens 501 and the G2 lens 502 as a light shield member. The fixed diaphragm 503 is an annular member provided with an aperture 504 that opens as if framing a lens part of the G1 lens 501 so that a light passed through the lens part of the G1 lens 501 enters the G2 lens 502. The fixed diaphragm 503 controls an amount of light entering the G2 lens.

The members 501 to 503 provided in the lens unit 500 are fixed with adhesives. Different types of adhesives are used to different portions depending on viscosity of the adhesives. For example, a low viscous adhesive is used to be poured down from outer diameters (hereinafter, “peripheral edge”) of the members 501 to 503 so as to fill in the gaps among the member 501 to 503. Moreover, an adhesive having high viscosity is, for example, applied to each of the members 501 to 503 (for example, Japanese Patent Application Laid-Open Publication Nos. 2004-354709 and 2005-18024).

In the lens unit 500, the adjustment (hereinafter, “centering”) of the positions of the members 501 to 503 in planes perpendicular to a light axes is conducted. Thus, the members 501 to 503 are fixed in the imaging unit 500 so that the optical axes of the members 501 to 503 coincide. If the lenses to be fixed by adhesive has an outer diameter of several tens of millimeters, for example, the lenses in a digital still camera (hereinafter, “DSC”), it is not necessary to strictly manage the quantity and the position of application of the adhesive. Therefore, the adhesive can be applied to the members 501 to 503 in a fixed state after the centering is conducted.

On the other hand, for lenses having an outer diameter of several millimeters, such as the lenses equipped in a portable phone, it is often difficult to apply the adhesive to the members 501 to 503 in such fixed state. Therefore, such a technique is proposed that the centering is conducted after application of the adhesive to the members 501 to 503 when manufacturing small lens units.

When a low viscous adhesive is used in the above technique, the adhesive is easily spread into the entire gaps between the G1 lens 501 and the fixed diagram 503, for example. The low viscous adhesive also easily reaches the vicinity of the aperture 504 of the fixed diaphragm 503 when applying the adhesive from the peripheral edge.

However, if the centering is conducted while the adhesive is spread into the entire gaps between the G1 lens 501 and the fixed diaphragm 503, the adhesive overflows from between the G1 lens and the fixed diaphragm 503 into the lens part of the G1 lens 501. The overflowed adhesive deteriorates the optical performance of the lens unit 500.

Increasing the viscosity of the adhesive can be considered to avoid the adhesive spreading into the aperture 504. However, it is difficult to attain sufficient boding strength with a high viscous adhesive having viscosity higher than 30000 mPa·s, which is an adhesive generally used.

### SUMMARY OF THE INVENTION

It is an object of the present invention to at least solve the above problems in the above conventional technologies.

An optical device according to one aspect of the present invention has a plurality of optical members arranged along an optical axis. The optical device includes a light transmissive member that passes light along the optical axis; a light shielding member that includes an aperture open trough in a direction of the optical axis, and that passes the light through the aperture toward a direction opposite to the light transmissive member, the light that has been passed through the light transmissive member; a washer member that is provided on the light shielding member, and that has a portion facing the light transmissive member at a position corresponding to a portion outside the aperture of the light shielding member when arranged concentrically about the optical axis; and an adhesive that bonds the light transmissive member and a fixed member that is fixed with respect to the optical axis.

An imaging device according to another aspect of the present invention includes the optical device according to the above aspect; and an imaging mechanism that includes a photoelectric conversion device that converts incident light input through the optical device into an electric signal.

An electronic device according to still another aspect of the present invention includes the optical device according to the above aspect; an imaging mechanism that includes a photoelectric conversion device that converts incident light input through the optical device into an electric signal; and an operation receiving unit that receives an operation instruction externally input.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a perspective view of a lens device according to a first embodiment of the present invention;

FIG. 2 is a cross-section of a lens device according to the first embodiment;

FIG. 3A is a front view of a digital camera according to a second embodiment of the present invention;

FIG. 3B is a rear view of the digital camera according to the second embodiment;

FIG. 4A is a front view of a portable phone according to a third embodiment of the present invention;

FIG. 4B is a rear view of the portable phone according to the third embodiment; and

FIG. 5 is a cross-section of a conventional lens unit.

### DETAILED DESCRIPTION OF THE PREFERRED EMBODIMENTS

Exemplary embodiments according to the present invention will now be described in detail with reference to the accompanying drawings. In the present embodiments, an example of a lens device will be explained that realizes an optical device according to the present invention.

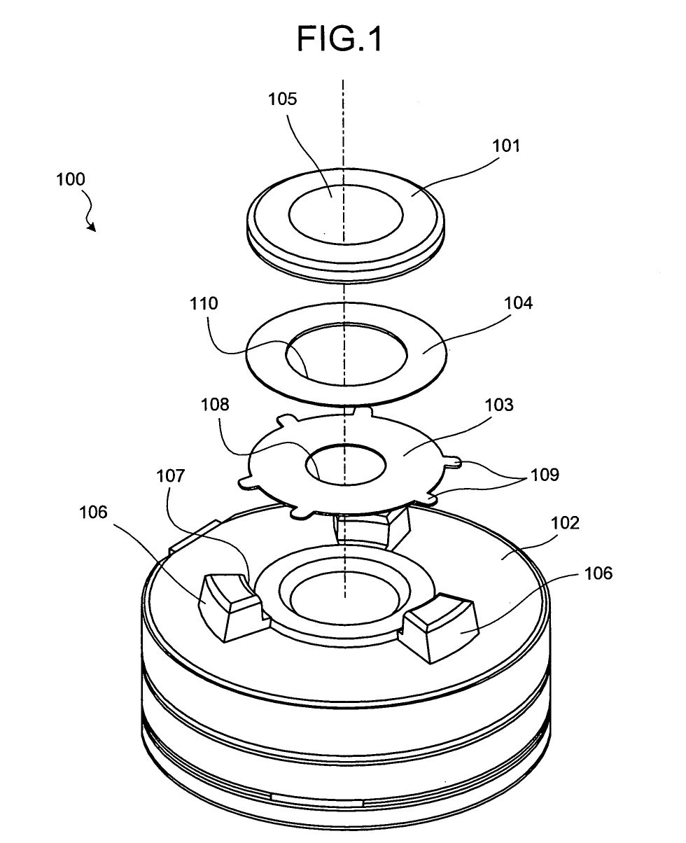

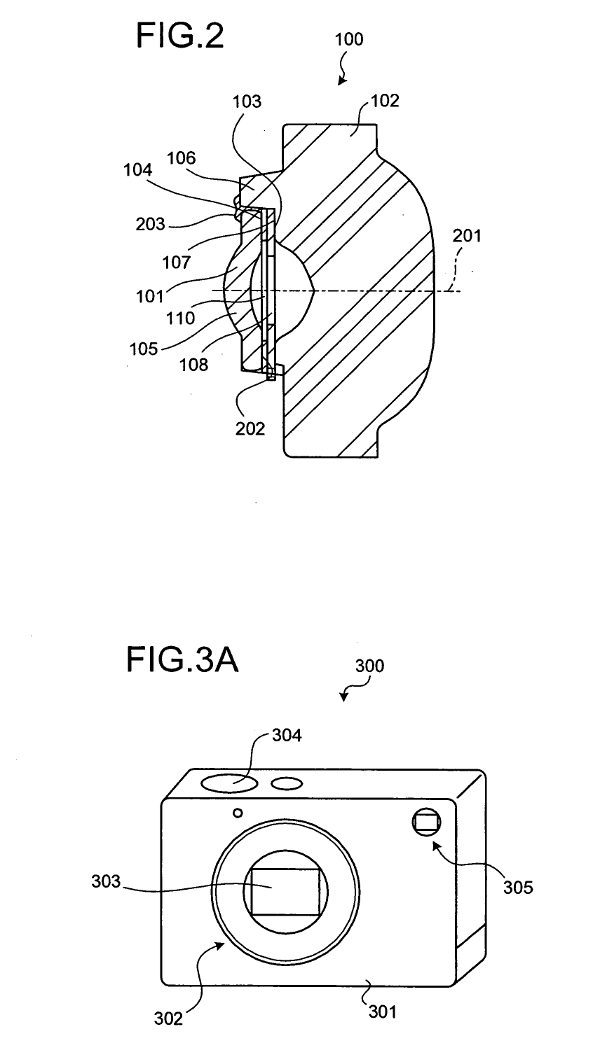

FIG. 1 is a perspective view of a lens device 100 according to a first embodiment, and FIG. 2 is a cross-section of the lens device. As shown in FIGS. 1 and 2, the lens device 100 includes a plurality of lenses 101 and 102, a fixed diaphragm 103, and a washer 104. Among the lenses 101 and 102, the lens 101 will be referred to as G1 lens and the lens 102 will be referred to as G2 lens in the first embodiment.

The G1 lens 101, the G2 lens 102, the fixed diaphragm 103, and the washer 104 are arranged in the order of the G1 lens 101, the washer 104, the fixed diaphragm 103, and the G2 lens 102 along the direction of the optical axis of the lens device 100.

The G1 lens 101 is a convex lens has a protruding lens portion 105, and is arranged such that the lens portion 105 protrudes in the direction opposite to the G2 lens 102, and that the top of the protrusion of the lens portion 105 meets an optical axis 201 shown FIG. 2. The lens portion 105 is implemented at the position overlapping the optically effective area of the G1 lens 101.

A G1R2 plane 202 is provided at the peripheral of the lens portion 105. The G1R2 plane 202 is a plane of the G1 lens 101 on a side of the G2 lens 102, and is a flat plane perpendicular to the optical axis 201. The G1 lens 101 is configured to be adjusted a position thereof in a plane perpendicular to the optical axis 201 by sliding the G1R2 plane 202 against the washer 104. The G1 lens 101 serves as a centering lens in the first embodiment.

The G2 lens 102 includes ribs 106 protruding toward the G1 lens 101. The ribs 106 are arranged at three points so that distances therebetween is equal to each other and distances from each point to the optical axis 201 are equal. A platform 107 is formed in each of the ribs 106 to position the G1 lens 101, the fixed diaphragm 103, and the washer 104. Members fixed about the optical axis with the ribs 106 are realized in the first embodiment.

When manufacturing the lens device 100, by sequentially placing the fixed diaphragm 103, the washer 104, and the G1 lens 101 to the platform 107 at the ribs 106, the G1 lens 101, the washer 104, and the fixed diaphragm 103 are positioned with respect to the G2 lens 102. The G1 lens 101 is arranged such that the position thereof is adjustable within a plane perpendicular to the optical axis 201, the G1 lens 101 displaceable while being placed at the platform 107.

The fixed diaphragm 103 is an annular member that controls an amount of light entering the G2 lens 102 so that light entered into the lens portion 105 of the light entered the G1 lens 101 passes through to the G2 lens 102. The fixed diaphragm 103 has an aperture 108 that is an opening open so as to frame the lens portion 105. The diameter of the aperture 108 is designed to be equivalent to the outer diameter of the lens portion 105.

At an outer edge of the fixed diaphragm 103, a positioning member 109 is arranged to position the fixed diaphragm 103 with respect to the G2 lens 102. Three pairs of the positioning member 109 are formed in protrusions that protrude from the peripheral edge of the fixed diaphragm 103 toward the outside of a circular shape of the fixed diaphragm 103, to concentrically position the fixed diaphragm 103 to the G2 lens 102 by sandwiching each the ribs 106 with each pair.

The washer 104 has an aperture 110 that is an opening to pass the light toward the fixed diaphragm 103, the light that has passed the lens portion 105 at the G1 lens 101. The diameter of the aperture 110 is designed to be larger than the outer diameter of the lens portion 105. In the first embodiment, the washer 104 realizes a gap member, and the aperture 110 realizes a sub-aperture.

More specifically, the size of the diameter of the aperture 110 is designed so that the displacement amount for which the G1 lens 101 placed at the platform 107 can be displaced in the direction of the diameter of the aperture 110 is smaller than the difference between the outer diameter of the lens portion 105 and the aperture 110.

An adhesive 203 bonds the G1 lens 101 and the washer 104. The adhesive 203 is adjusted to have such viscosity that when the adhesive is applied, the adhesive spreads into the entire gaps between the G1 lens 101 and the washer 104. However, the viscosity of the adhesive 203 after the bonding of the G1 lens 101 and the washer 104 is not limited to this.

An example of the adhesive 203 includes an adhesive having an ultraviolet (UV) curable resin as main ingredient that is cured as exposed to an ultraviolet ray can be applied. Other examples of the adhesive 203 include a cyanoacrylate adhesive that bonds the G1 lens 101 and the washer 104 by reacting with moisture in the atmosphere, etc., and a solvent adhesive that bonds the G1 lens 101 and the washer 104 by dissolving a part of the G1 lens 101 and the washer 104 with a solvent that evaporates thereafter.

When manufacturing the lens device 100 in this type of configuration, the fixed diaphragm 103, the washer 104, and the G1 lens 101 are sequentially placed at the platform 107 of the G2 lens 102. In this way, the G1 lens 101, the washer 104, and the fixed diaphragm 103 are positioned to the G2 lens 102. The fixed diaphragm 103 is placed at the platform 107 with the adhesive 203 applied between the G2 lens 102 and the fixed diaphragm 103, and in this state, the G1 lens 101 is placed to the fixed diaphragm 103.

The adhesive 203 is then injected between surfaces of the ribs 106 closer to the optical axis 201 and the peripheral edge (rim) of the G1 lens 101. The viscosity of the adhesive 203 is set low so that the adhesive spreads by capillary action into the gaps between the G1 lens 101 and the washer 104 and between the fixed diaphragm 103 and the washer 104.

Centering of the G1 lens 101 is then conducted by displacing the G1 lens 101 in a plane parallel to the plane perpendicular to the optical axis 201. As described, in the lens device 100, the displacement amount of the G1 lens 101 that is displaceable in the diameter direction of the aperture 110 while placed at the platform 107 is designed to be smaller than the difference between the outer dimension of the lens portion 105 and the aperture 110 in the diameter direction of the aperture 110.

An end closer to the optical axis 201 at a contact part where the washer 104 and the G1R2 plane contact is never positioned closer to the optical axis 201 than the outer part of the lens part 105. Therefore, the overflowed adhesive 203 does not deteriorate the optical performance of the lens device 100 even when the adhesive 203 between the G1 lens 101 and the washer 104 overflowed from between the G1 lens 101 and the fixed diaphragm 103.

The lens device 100 of the first embodiment enables to prevent the adhesive 203 from spreading into the aperture while fixing the position of the G1 lens 101 to the optical axis 201, regardless of the placement of the adhesive 203 for bonding the G1 lens 101 to the ribs 106, since the adhesive 203 between the G1 lens 101 and the washer 104 exists closer to the periphery than the aperture 108.

The lens device 100 of the first embodiment also prevents the adhesive 203 from spreading into the aperture while fixing the position of the G1 lens 101 to the optical axis 201, regardless of the adjusted position of the G1 lens 101, since the adhesive for bonding the G1 lens 101 and the washer 104 exists closer to the periphery than the aperture.

In this way, the lens device 100 enables to prevent deterioration in the optical performance resulted from the interference of the optical path by the adhesive spreading closer to the optical axis in the aperture. As a result, a user of the lens device 100 can use the highly reliable lens device 100 with ensured optical performance.

The lens device 100 of the first embodiment also enables to accurately pass the light of which quality is maintained therethrough to in the opposite direction to the G1 lens 101 since the length of the aperture diameter of the aperture 108 provided by the fixed diaphragm 103 is smaller than the outer diameter of the lens portion 105 that is an optically effective area of the G1 lens 101.

Thus, the optical performance of the lens device 100 is improved. As a result, a user of the lens device 100 can use the highly reliable lens device 100 with high optical performance.

The lens device 100 of the first embodiment enables to prevent the adhesive from spreading closer to the optical axis in the aperture while fixing the position of the G1 lens 101 to the optical axis 201 with simple configuration since the length of the aperture diameter of the aperture 110 of the washer 104 is smaller than the outer diameter of the lens portion 105 that is an optically effective area of the G1 lens 101.

With the simple configuration, the lens device 100 enables to prevent degradation of the optical performance. As a result, a user of the lens device 100 can use the highly reliable lens device 100 with high optical performance.

Although a case is described that the fixed diaphragm 103 and the washer 104 are separate members in the first embodiment, the configuration is not limited to this. The washer 104 formed integrally with the fixed diaphragm 103 and the G1 lens 101 may be bonded with the adhesive 203.

Although the fixed diaphragm 103 is implemented as a light shielding member in the first embodiment, other forms can be implemented. For example, the light shielding member may be realized by a mask or a light shielding plate arranged so as to mask the peripheral edge of the lens as a measure against the ghost caused by the reflection of light in the lens device 100.

Although a case of fixing the G1 lens 101 is described in the first embodiment, the subject to be fixed by the adhesive 203 is not limited to the G1 lens 101. Other than the G1 lens 101, members arranged in a fixed state to the optical axis, such as the G2 lens 102, the mask, and the light shielding plate, may be the subject as long as the members are fixed using an adhesive of which viscosity is as low as that of the adhesive 203. In this case, the G2 lens 102, the mask, and the light shielding plate realize the light-transmissive members.

In the first embodiment, the adhesive 203 spreading closer to the optical axis in the aperture 108 can be prevented while fixing the position of the G1 lens 101 to the optical axis without affecting the light passing through the fixed diaphragm 103 since the size of the aperture 110 of the washer 104 is larger than the size of the aperture 108 of the fixed diaphragm 103.

With this simple configuration, the lens device 100 enables to prevent degradation of the optical performance. As a result, a user of the lens device 100 can use the highly reliable lens device 100 with high optical performance.

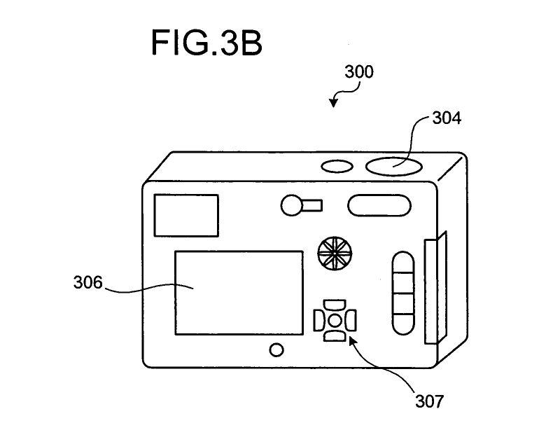

FIG. 3A is a front view of a digital camera according to a second embodiment of the present invention, and FIG. 3B is a rear view of the digital camera. The digital camera as an image pickup device of the second embodiment will then be described with reference to FIGS. 3A and 3B. The same parts as in the first embodiment will be illustrated with the same reference numerals in the second embodiment and will not be described.

As shown in FIG. 3A, a lens device 302 is arranged in front of a housing 301 of a digital camera 300 of the second embodiment. The lens device 302 provides a similar configuration as the lens device 100 described in the first embodiment and the G1 lens is arranged to be in front of the G2 lens.

The lens device 302 is provided with a shutter 303 that covers up the G1 lens. The shutter 303 opens and closes in response to ON/OFF of a power supply of the digital camera 300. The shutter 303 opens the G1 lens to the outside when the power supply is ON. Reference numeral 304 of FIG. 3 represents a release button that is pressed when photographing, and reference numeral 305 represents a flash lamp.

Although not shown, an image pickup mechanism is provided in the housing 301, the image pickup mechanism including a photoelectric conversion device for imaging that converts a light entered through the lens device 302 to an electric signal. A charge-coupled device (CCD) can be used as a photoelectric conversion device, for example.

As shown in FIG. 3B, a display 306 is arranged on the rear side of the housing 301. The display 306 displays an image based on image data obtained by converting the light that has entered the photoelectric conversion device through the lens device 302 into an electric signal. An operation key 307 is also arranged on the rear side of the housing 301, the operation key accepting an input operation by a user to the digital camera 300.

As described, the digital camera 300 of the second embodiment is capable of imaging through the lens device 302 with high optical performance. In this way, the digital camera 300 acquires high quality images. This allows a user of the digital camera 300 to obtain high quality images.

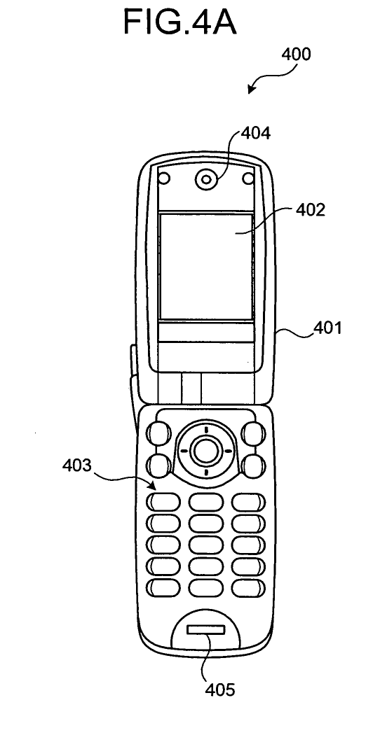

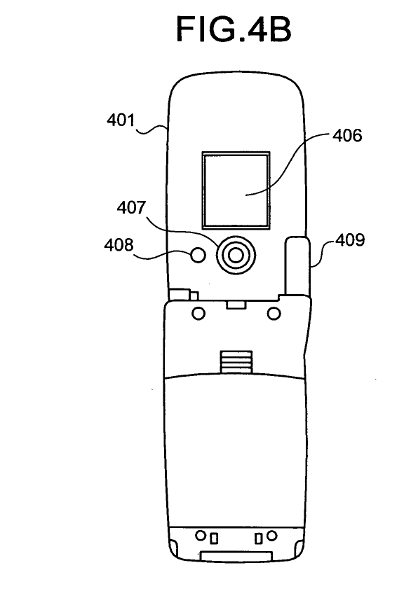

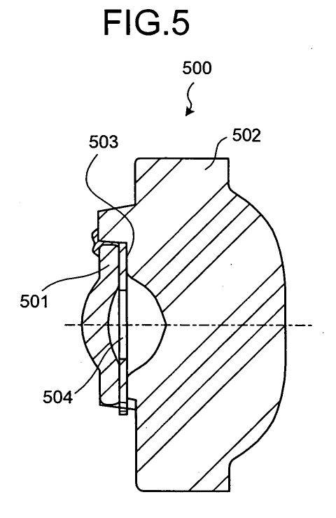

FIG. 4A is a front view of a portable phone according to a third embodiment of the present invention, and FIG. 4B is a rear view of the portable phone. The portable phone as electronic equipment of the third embodiment according to the present invention will then be described with reference to FIGS. 4A and 4B. The same parts as in the first and the second embodiments will be referred to by the same reference numerals in the third embodiment and will not be described.

As shown in FIG. 4A, a main display 402 and a plurality of operation buttons 403 are arranged at a front side of a housing 401 of a portable phone 400. A speaker 404 that outputs sound and a microphone 405 that inputs sound, such as voice of the user, are also arranged at the front side.

As shown in FIG. 4B, a sub-display 406, a lens device 407, a flash light-emitting-diode (LED) 408, and an antenna 409 are arranged on a rear side of the housing 401. The lens device 407 provides a similar configuration as the lens device 100 described in the first embodiment, and the G1 lens is arranged to be closer to the front than the G2 lens. Although not shown, an image pickup mechanism is provided in the housing 401, the image pickup mechanism including a photoelectric conversion device, such as a CCD, that converts a light entered through the lens device 407 into an electric signal.

As described, in the portable phone 400, degradation of the optical performance of the lens device 407 is prevented even when the lens device 407 is downsized to be mounted on the portable phone 400 that is downsized to be portable. This allows a user of the portable phone 400 to use the highly reliable portable phone 400 with high optical performance.

As described, in the lens device 100, the digital camera 300, and the portable phone 400 of the embodiments, it is possible to prevent degradation of the optical performance by avoiding the adhesive from spreading closer to the optical axis in the aperture to interfere the optical path, and to ensure excellent optical performance.

According to the embodiments described above, it is possible to prevent degradation of optical performance. The present document incorporates by reference the entire contents of Japanese priority document, 2006-230558 filed in Japan on Aug. 28, 2006.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An optical device including a plurality of optical members arranged along an optical axis, comprising:
a light transmissive member that passes light along the optical axis;
a light shielding member that includes an aperture open trough in a direction of the optical axis, and that passes the light through the aperture toward a direction opposite to the light transmissive member, the light that has been passed through the light transmissive member;
a washer member that is provided on the light shielding member, and that has a portion facing the light transmissive member at a position corresponding to a portion outside the aperture of the light shielding member when arranged concentrically about the optical axis; and
an adhesive that bonds the light transmissive member and a fixed member that is fixed with respect to the optical axis.

2. The optical device according to claim 1, wherein the adhesive is applied between the light transmissive member and the washer member.

3. The optical device according to claim 1, wherein the light transmissive member is a centering lens of which position is adjustable on a plane perpendicular to the optical axis.

4. The optical axis according to claim 1, wherein the washer member has an annular form having a second aperture open through in the direction of optical axis, the second aperture having a sizes larger than a size of an optically effective region in the light transmissive member.

5. The optical device according to claim 4, wherein the size of the second aperture is larger than a size of the aperture.

6. An imaging device comprising:
an optical device including
a light transmissive member that passes light along the optical axis;
a light shielding member that includes an aperture open trough in a direction of the optical axis, and that passes the light through the aperture toward a direction opposite to the light transmissive member, the light that has been passed through the light transmissive member;
a washer member that is provided on the light shielding member, and that has a portion facing the light transmissive member at a position corresponding to a portion outside the aperture of the light shielding member when arranged concentrically about the optical axis; and
an adhesive that bonds the light transmissive member and a fixed member that is fixed with respect to the optical axis; and
an imaging mechanism that includes a photoelectric conversion device that converts incident light input through the optical device into an electric signal.

7. An electronic device comprising:
an optical device including
a light transmissive member that passes light along the optical axis;
a light shielding member that includes an aperture open trough in a direction of the optical axis, and that passes the light through the aperture toward a direction opposite to the light transmissive member, the light that has been passed through the light transmissive member;
a washer member that is provided on the light shielding member, and that has a portion facing the light transmissive member at a position corresponding to a portion outside the aperture of the light shielding member when arranged concentrically about the optical axis; and
an adhesive that bonds the light transmissive member and a fixed member that is fixed with respect to the optical axis;
an imaging mechanism that includes a photoelectric conversion device that converts incident light input through the optical device into an electric signal; and
an operation receiving unit that receives an operation instruction externally input.
